(19) United States
(12) Patent Application Publication
(10) Pub. No.: US 2002/0145271 A1
(43) Pub. Date: Oct. 10, 2002

(54) Wheelchair and power booster wheel assembly for conversion of conventional wheelchairs

(76) Inventor: Alphonso V. Sanchez, Santa Barbara, CA (US)

Correspondence Address: LAW OFFICES OF JOHN E. WAGNER, 3541 Ocean View Boulevard, Glendale, CA, 91208, US

(21) Appl. No.: 10/046,455

(22) Filed: Jan. 10, 2002

Related U.S. Application Data
(63) Continuation-in-part of application No. 09/226,790, filed on Jan. 7, 1999.
(60) Provisional application No. 60/070,872, filed on Jan. 9, 1998.

(51) Int. Cl. B62B 1/00

(52) U.S. Cl. 280/658

(57) ABSTRACT

An improved wheelchair and power booster is disclosed. It employs a drive/brake system incorporated in each main wheel connected to lever arms for propelling the wheelchair by engaging the brake and moving the lever arms either forward or rearward to move the associated main wheel forward or backward. Releasing the brakes allows free wheeling. A parking brake lock loop which is located on the lever on the arm locks the brakes. A single front wheel is utilized when pivoted from a leg foot rest. The front wheel may caster freely or may be controlled directly by a manual steering handle. The main wheels are removable for transport and storage and the frame folds to a compact generally rectangular shape for easy carrying along with the wheels in a passenger vehicle. The frame also is designed with a U shaped frame member open at the rear and the seat moves out of place to allow the wheelchair to be backed over a residential or commercial toilet to allow the wheelchair occupant to use such facilities without leaving the wheelchair. A booster assembly including a replacement main wheel with an internal brake and a lever arm rotatably secured to the wheel hub through the brake is provided as a replacement for conventional wheelchair main wheels. The booster assembly includes a brake actuating control and a parking lock located at the hand grip end of the lever arm.

### BACKGROUND OF THE INVENTION

Through the years, many have attempted to modify wheelchairs by improving the wheelchair's mobility and by improving user safety. Recently, the advent of new high-strength materials and the increased desire of disabled persons to compete have fostered the development of racing wheelchairs. It still remains true, however, that propulsion typically occurs either as a result of an assistant pushing the wheelchair from behind or the wheelchair user rotating the main wheels by hand using wheel-mounted rings. The alternative to these traditional modes of locomotion seems to be an electric battery-powered wheelchair or vehicle.

Examples of alternate forms of wheelchair propulsion may be found in the following United States patents:

| | | |
|---|---|---|
| 5,577,748 | Dombrowski et al. | November 26, 1996 |
| 5,509,673 | Wu et al. | April 23, 1996 |
| 5,322,312 | M. A. Cammack | June 21, 1994 |
| 5,263,729 | Watwood et al. | November 23, 1993 |
| 5,241,876 | T. Mathis | September 7, 1993 |
| 5,232,236 | E. Korpi | August 3, 1993 |
| 5,020,815 | Harris et al. | June 4, 1991 |
| 5,007,655 | M. Hanna | April 16, 1991 |
| 4,811,964 | S. J. Horn | March 14, 1989 |
| 4,762,332 | Main T. Seol | August 9, 1988 |
| 4,682,784 | J. E. Anderson | July 28, 1987 |

These patents illustrate the recognized need for improved wheelchair propulsion systems.

It is also recognized that there is a need for such wheelchairs to be compact and foldable so that the wheelchair can easily accompany the user in, for example, an automobile. In the past this has normally been accomplished by folding the two sides of the wheelchair with their wheels attached inward, with the seat and back areas collapsing so as to bring the overall width of the folded wheelchair to about twelve inches. The folded wheelchair can then be placed behind the front seat area or the trunk of a vehicle. This type of folding wheelchair may be satisfactory when the wheelchair occupant has an attendant to assist in the folding and placement of the wheelchair in the vehicle. This type of folding design, however, would be difficult for almost all wheelchair users whose impairment precludes them from folding the wheelchair and/or placing it behind the seat or into the trunk. I recognized that wheelchair users often times have a high degree of mobility in their arms and with that factor in mind I developed a wheelchair which is easily foldable by most wheelchair occupants.

### BRIEF DESCRIPTION OF THE INVENTION

Faced with the foregoing state-of-the-art, I realized that a significant advance in the state-of-the-art could be accomplished in occupant-propelled wheelchairs where the occupant employs his/her upper body strength in a more efficient manner than merely driving the wheels directly by moving the wheel rings or by the various other types of drive systems. It appears to me that the occupant would be more comfortable and have more efficient driving and braking of the wheelchair if a simple lever drive system were utilized.

It also appears to me that the incorporation of a brake into each wheel with a lever arm and a brake engagement handle for each wheel should be used. The lever arm, which I term the “mobility booster”, has a length greater than the main wheel's radius and consequently will have a greater momentum arm for driving its associated wheel. Additionally, the lever is operated from the occupant's lower chest region and involves a more natural movement of simply extending the user's arms forward from a position above the user's waist and then returning the arms beside the chest, generally in the armpit region.

I also determined that an efficient brake built into each wheel can act not only to stop the wheel but also act as the drive member for moving the wheelchair main wheels either forward or rearward. Each lever arm includes a finger-operated brake handle. When the brake handle is depressed, the brake engages for either forward or rearward movement or holds the wheel immobile. When the brake handle is released, the wheel is free to turn or free wheel.

The action of propelling the wheelchair in accordance with this invention is somewhat similar to the act of rowing a boat in which the oar handles are moved forward out of the water in a feathered position, then twisted and dropped into the water to engage the water as the rower pulls the oars back to drive the rowboat forward (toward the rower's back).

In the case of my invention, for forward propulsion, the occupant of the wheelchair with his hands on the lever which is near his chest, depresses the brake handles of both main wheels to engage the brakes to their respective wheel and straightens his arms forward and then releases the brake handles. The wheels are driven forward and then released for free rolling. The occupant then withdraws his arms towards his chest returning the levers to their near-vertical position with the brake handles released. At the rearmost position that is comfortable for the occupant, he depresses the brake handles to engage the wheel again and straightens his arms forward to drive the main wheels forward again, then releasing the brake handles and allowing the main wheels and the wheelchair to free roll or coast. Thus, the same natural movements, as in rowing, are used. The levers or power boosters, being longer than the diameter of the main wheels, give not only a mechanical advantage to the forces applied by the wheelchair occupant as compared to operating the conventional hand ring of typical wheelchairs, but allows more precise control in starting, stopping and turning.

In order to reverse the wheelchair, the occupant grasps the levers, and with the brake handles released, straightens his arms forward, then depresses the brake handles and draws his arms back towards his chest and releases the brake lever to allow the wheelchair to coast to the rear. Repeating this cycle propels the wheelchair backwards.

Another aspect of this invention provides for improved steering. The presence of a single front wheel and a short tiller bar and handle facilitates steering with one or both hands. Allowing the operator to steer with one hand frees the wheelchair operator to drive the wheelchair with the other hand by manipulating a single mobility booster. The ability to steer the inventive wheelchair with only one hand is also beneficial to those occupants whose strength is primarily located in one arm.

Another feature of this invention is that the camber angle of the wheels may be easily adjusted to provide, among other things, greater stability, similar to that usually found only in racing wheelchairs. This ability to change the camber angle can also be used to adjust the positions of the power boosters for user comfort.

This invention also affords a degree of unassisted lifestyle heretofore unavailable to most wheelchair occupants. The inventive wheelchair also has a greater degree of clearance side to side and floor to the underside of the seat when viewed from the rear as compared to other wheelchairs. The wheelchair also has an open back, and with the other previously described features, allows the user to back the wheelchair over a conventional toilet. Further, the wheelchair provides for the seat to move such that the occupant may utilize a conventional toilet without actually leaving the wheelchair.

After removing the main wheels, the wheelchair of my invention is foldable into a compact package with the dimensions of approximately 16-inches wide by 19 inches in depth by 8 inches in height. Thus, the inventive wheelchair is easily stored or transported in, for example, an automobile. The main wheels are easily removed, and in the occasion of an automobile, may be stored behind the front seat for simple reassembly and use at the end of a trip.

One other feature of the invention is that the wheel and lever assembly are not only removable for storage and ease of transport, but also have separate utility as replacement wheels for the main wheels of a conventional wheelchair. This affords the advantages of retrofitting convention wheelchairs with the mobility booster of this invention without incurring the expense of purchasing a new wheelchair.

Conventional wheelchairs are generally capable of accepting the inventive wheel with center hub and brake. After conversion, a conventional wheelchair is able to utilize the leverage principle of my booster arm, controlled by a leveraged handgrip and utilizes the brake shoes within the hub of the main wheels for both driving and braking the wheelchair. The brake shoes are engaged through a metal control cable or rod, which extends from the center wheel housing parallel to the booster lever arm. Releasing the booster arm permits a freewheeling of the wheel. By reversing the process, backward mobility is accomplished.

The occupant operating my improved wheelchair or a modified conventional wheelchair having my mobility booster lever arm wheels and brake assembly is able to propel the wheelchair forward and backward as fast as safety will allow and with much less effort than is required to mobilize a conventional wheelchair having a traditional “hand rim” wheel. Because movement requires far less dexterity when my mobility booster wheel assembly is used, steep inclines, handicap ramps, and curb ramps are negotiated with much greater ease. Smooth, safe, downhill movement and stopping are also facilitated. The use of the mobility booster wheel assembly encourages self-reliance, offers newfound freedom, helps to overcome physical limitations and provides faster, low-effort mobility.

### BRIEF DESCRIPTION OF THE DRAWING

This invention may be more clearly understood from the following detailed description and by reference to the drawing in which:

FIG. 1 is an exploded view of the first embodiment of this invention with the actual padded seat and backrest portions removed to aid in the understanding of the invention and its operation;

FIG. 2 is a side elevational view, partly broken away, showing the invention and its mode of propulsion;

FIG. 2A is a fragmentary side elevational view of the mobility booster arm handgrip area showing its preferred parking brake lock;

FIG. 2B is a fragmentary front elevational view of the handgrip area and parking brake lock of FIG. 2A;

FIG. 3 is a fragmentary side elevational view of the frame of this invention showing an arrangement for folding the frame;

FIG. 4 is a fragmentary sectional view taken along lines 4-4 of FIG. 2 showing the propulsion and drive braking assembly of this invention;

FIG. 5 is a fragmentary enlarged side elevational view of the drive braking and propulsion system of FIGS. 2 and 4 with portions broken away to facilitate the understanding of this portion of the invention;

FIG. 6 is a vertical sectional view taken along lines 6-6 of FIG. 1 showing the camber adjustment of the wheels of this invention;

FIG. 7 is a fragmentary vertical sectional view, similar to FIG. 6, with the wheel shown in the maximum camber adjusted position;

FIG. 8 is a perspective view of a third wheel and steering arrangement of this invention with an alternate form of swiveling caster third wheel, which may be used in place of the wheel shown already attached to the steering assembly;

FIG. 9 is a side elevational view of the frame, seat, and backrest, as well as footrest combination of the process of being folded for transport with the main wheels removed;

FIG. 10 is a side elevational view, similar to FIG. 9, with the frame assembly fully folded;

FIG. 11 is a side elevational view of an occupant in the wheelchair of this invention in the process of traveling down an inclined surface;

FIG. 12 is a side elevational view of the wheelchair of this invention positioned over a normal household commode with the seat cushion of the wheelchair seat folded and retracted to allow virtually unassisted use of the conventional commode by a wheelchair confined patient;

FIG. 13 is a front elevational view of the wheelchair in the position shown in FIG. 12;

FIG. 14 is a top plan view of this invention shown with the occupant steering and propelling the wheelchair using a single hand;

FIG. 15 is a top plan view, similar to FIG. 14, with the occupant steering in the opposite direction from FIG. 14 while using a single hand;

FIG. 16 is a side elevational view of an alternate form of folding frame of this invention with the user and main wheel shown in dashed lines;

FIG. 17 is a front elevational view of the alternate form of the frame of FIG. 16 with the user and main wheels shown in dashed lines;

FIG. 18 is a top plan view of the frame of FIG. 16 in its open or unfolded condition;

FIG. 19 is a side elevational view of the alternate form of the frame of FIG. 16 folded;

FIG. 20 is a top plan view of the frame of FIG. 16 folded with the folded backrest partially broken away;

FIG. 21 is a side elevational view of a conventional wheelchair and ready for substitution of mobility booster wheels of this invention;

FIG. 22 is a side elevational view of a mobility booster wheel of this invention ready to be substituted for the standard wheels of the wheelchair of FIG. 21 for lever-operated drive and steering;

FIG. 23 is a side elevational view of the wheelchair of FIG. 21 with the mobility booster wheels of FIG. 22 replacing the conventional main wheels of the wheelchair of FIG. 21;

FIG. 24 is a side elevational view of the removed conventional wheel of FIG. 21; and

FIG. 25 is a side elevational view of a passenger vehicle, partly broken away, showing a wheelchair user in the front right-hand seat with the wheelchair frame folded below his feet and the main wheels stored behind the front seats of the vehicle.

### DETAILED DESCRIPTION OF THE INVENTION

General Assembly

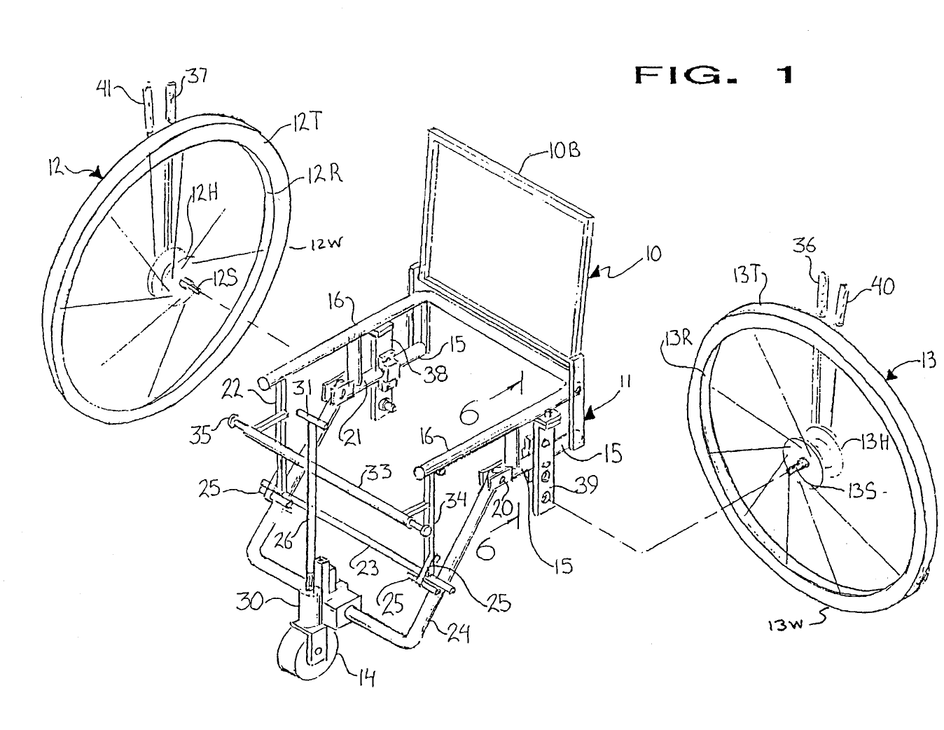

The basic parts of a wheelchair of this invention, generally designated 10, may be seen in exploded view of FIG. 1. The seating and backrest have been removed in order to show the details of the frame assembly 11, the mobility booster wheel assemblies 12 and 13, and the steering controlled front wheel 14. The frame assembly 11 includes a base section 15 with an upper U-shaped seat support 16, and main wheel support brackets 20 and 21 on the wheelchair user's left and right side, respectively. A footrest 24, which also acts as the front wheel-mounting bracket, is pivotally secured to the main wheel support brackets 20 and 21. A footrest stop bar 23, with locking mechanism 25, secure the footrest 24 when in use and release it for folding of the frame assembly 11.

The single front wheel 14 is mounted on a vertical shaft 26 and journaled in bracket 30 for steering by small steering arm 31 at the top of shaft 26. The shaft 26 and steering arm 31 are removable at any time when front wheel hand steering is not desired or for entrance or exiting the wheelchair 10. The steering arm arrangement of FIG. 1 is a feature which allows precise steering movement since the wheel 14 is journaled directly under the shaft 26. With this arrangement, for every 1 degree of rotation of the steering arm 31, there is 1 degree of pivoting of the axle of the front wheel 14. Small wheel steering does not require any forward or rearward movement of the wheelchair as in the case of trailing free steering front wheels that are common in wheelchairs.

The front ends of the U-shaped seat support 16 are supported by downward extending brackets 22, which are latched to footrest stop bar 23 by locking mechanisms 25 to add rigidity to the front of the frame assembly 11. A pair of stops 34 and 35 are located at each side of the frame 11 which serve as front stops and rests for the manually operated mobility booster lever arms 36 and 37, and which are attached, respectively, to the wheel assemblies 12 and 13 and are described in more detail below. Each mobility booster lever arm 36 and 37 has a handgrip and a nearby parking brake operating handles 40 and 41, respectively.

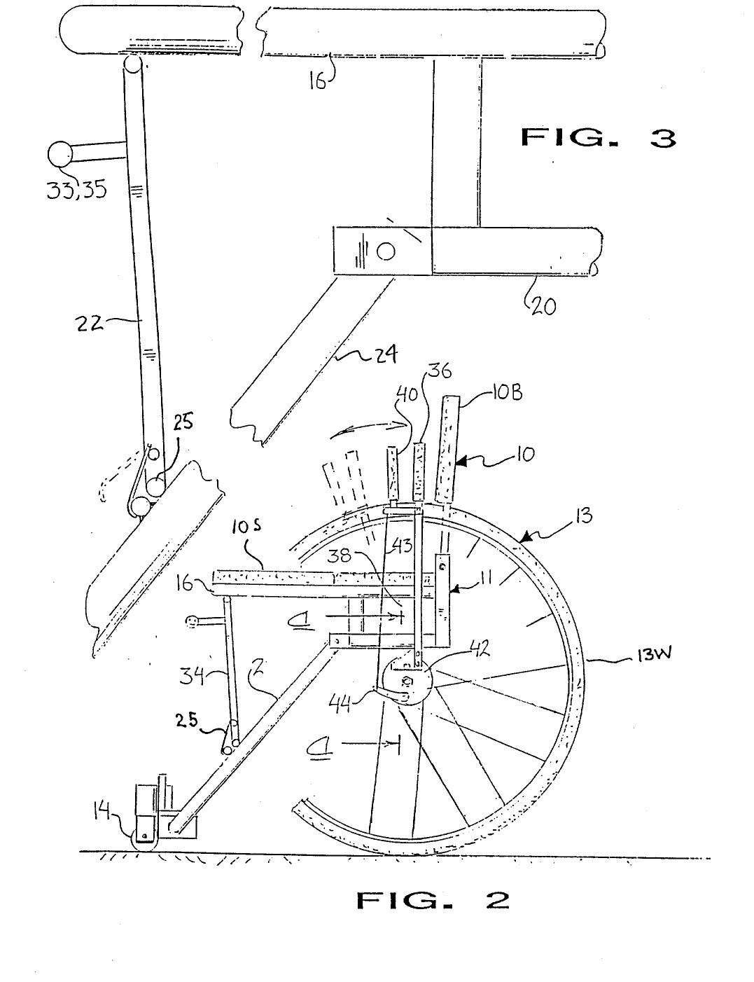

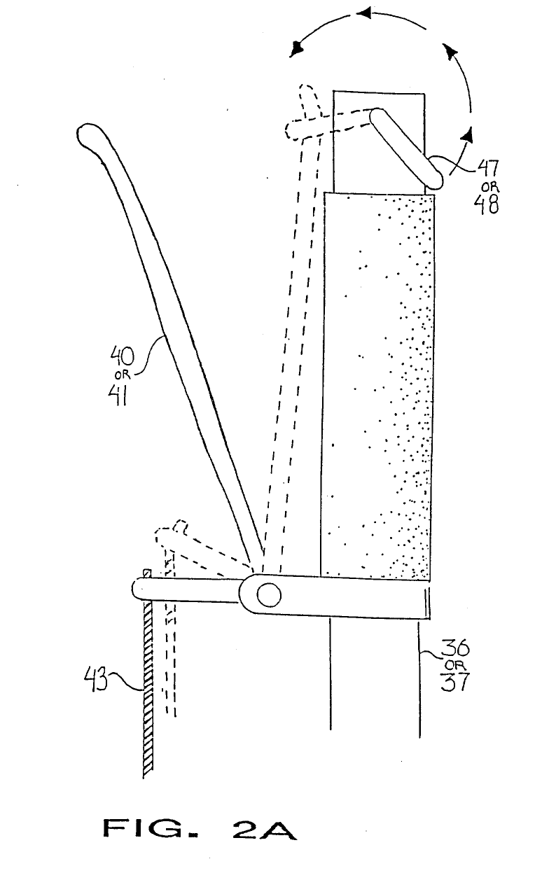

The wheel assemblies 12 and 13, in addition to having rims 12R and 13R and tires 12T and 13T, each have a hub 12H and 13H, a shaft 12S and 13S, and an internal brake 12B and 13B, better seen in FIGS. 2, 4, and 5. The brake 12B and 13B are each operated individually by the wheelchair occupant squeezing the brake-operating handles 40 and 41 and moving them toward their respective mobility booster lever arm 36 or 37 in a conventional handgrip brake operation, which is familiar and natural for most people. The mobility booster lever arms 36 and 37 are directly connected to the hub of their respective wheels.

The brakes 12B and 13B are contained within the hubs 12H and 13H are of the drum and shoe type. These drum and shoe-type brakes provide excellent braking which is important not only for stopping and parking the wheelchair but is used also as the driving connection between the mobility booster lever arms 36 and 37 and wheels 13W and 12W, respectively. These brakes do not add significantly to the width of the wheelchair, as they are located within each respective main wheel.

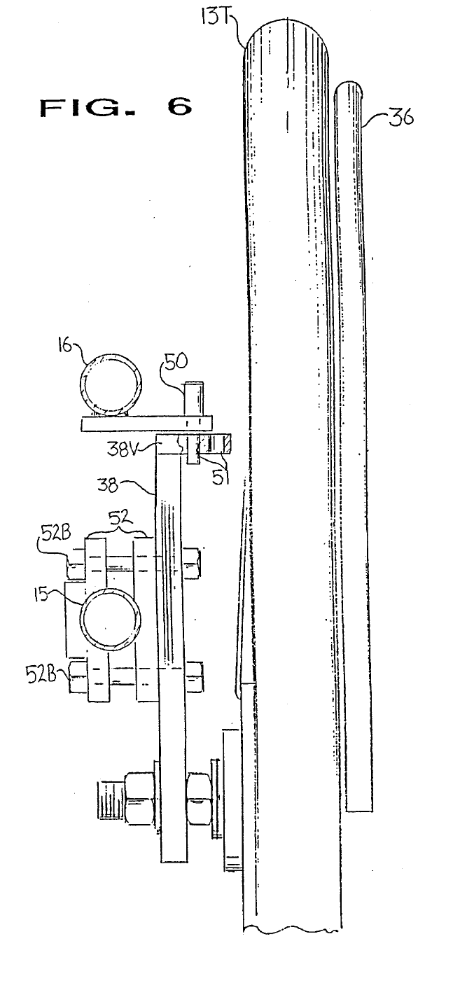

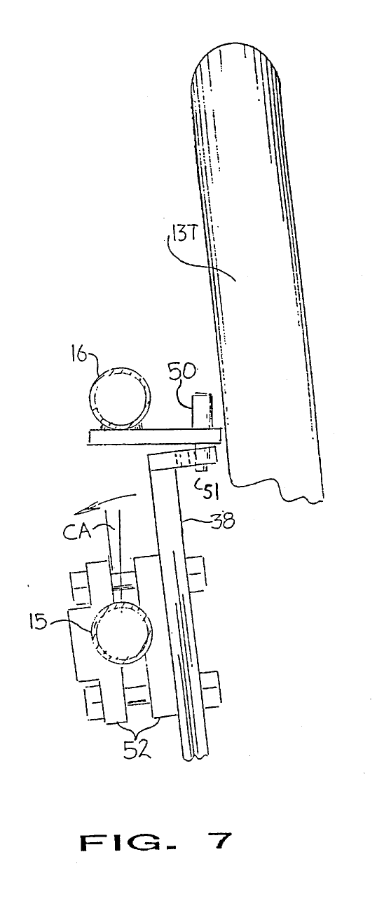

The base sections 15 of the frame 11 also includes a pair of wheel support plates 38 and 39 for the assembly of the wheels 12W and 13W to the frame 11. These plates 38 and 39 may be permanently secured to the frame 11 or as described below adjustable in camber angle as illustrated and described in connection with FIGS. 6 and 7.

Now referring specifically to FIG. 2 in connection with FIGS. 2A, 2B, and 3-5, the wheelchair 10 may be seen in FIG. 2 in its fully assembled condition with the seat 10S and backrest 10B in place as well as the wheel assemblies 12 and 13, only wheel assembly 13 being visible in FIG. 2. The mobility booster lever arm 36 is shown secured directly to the brake housing closing plate 42 and a brake operating rod or cable 43 is connected at its upper end to the brake-operating handle 40 and its lower end to a brake lever arm 44.

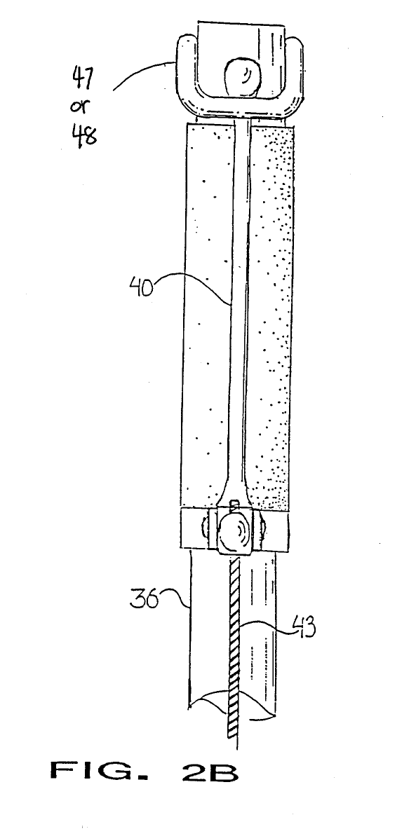

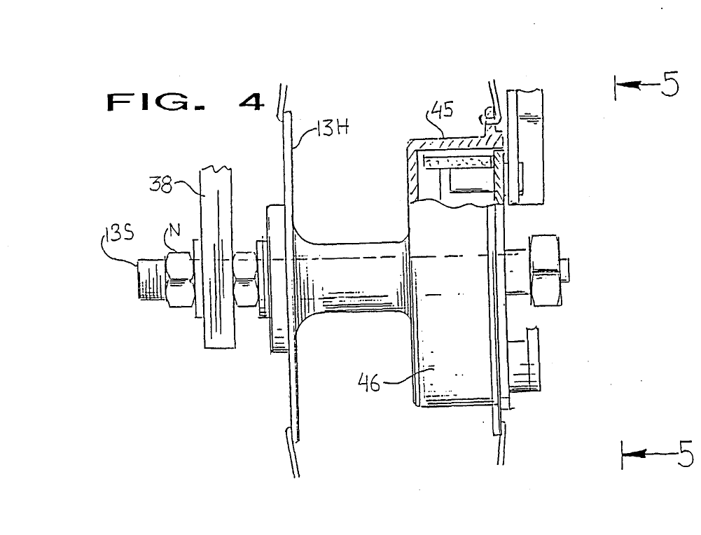

To engage the brake, one must squeeze the brake-operating handle 40 and/or 41 toward the mobility booster lever arm 36 or 37, which in turn moves the brake lever arm 44 or its counterpart on wheel 12W, counterclockwise in the drawing FIGS. 2 and 4, expanding an internal brake shoe 45 of FIG. 4 into contact with the main brake housing 46. This holds the mobility booster lever arm 36 in direct engagement with the wheel assembly 13 for rotation as long as the brake-operating handle 40 and/or 41 is held in this manner. When the mobility booster lever arm 36 is moved forward from the position shown in FIG. 2 to the dashed position of FIG. 2, approximately 15 degrees, the wheel assembly 13 rotates counterclockwise (forward) for the same amount, e.g., 15 degrees. If the brake-operating handle 40 is then released, the wheel 13W of the wheel assembly 13 is free to continue rolling, i.e., free wheeling until the brake-operating handle 40 or 41 is again operated to stop its associated wheel 12W or 13W from further rotation separate from the brake-operating handle 40 or 41.

While the wheel assemblies 12 and 13 are in free wheeling condition and the wheelchair is moving ahead, the mobility booster lever arms 36 and 37 may be freely drawn back to prepare for a second stroke, when the brake handles 40 and 41 are again engaged and a second drive boost is applied to wheels 12W and 13W. Such action is similar to the movement of the oarsman in a boat, only the direction of drive is direct rather than reverse as in the case of the oarsman. The wheelchair user may hold, for example, one wheel 13W locked by squeezing and maintaining brake-operating handle 40 and holding the mobility booster lever arm 36 immobile while pumping the other mobility booster lever arm 37 with its brake engaged such that it allows the user in this example to pivot the wheelchair to the left about locked wheel 13W. The front wheel 14 will turn 90 degrees and track the rotation of the wheelchair 10.

To hold the wheelchair in a fully braked condition at any time or any place without the need to continually hold the brake handle 40 or 41, the wheelchair user may engage the brake locking ring 47 or 48 shown in FIGS. 2A and 2B into the locked position as shown in FIG. 2B as compared to the normally released position of FIG. 2A.

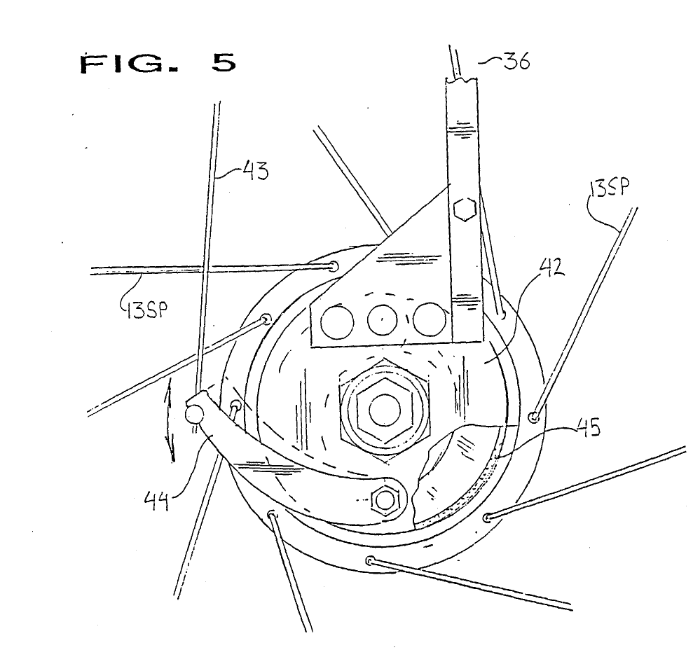

The details of the footrest stop bar 23 for the footrest 24 and locking mechanisms 25 may be seen in FIG. 3, while the detail of the brake system, which is integral to the wheels, appears in FIGS. 4 and 5.

Camber Adjustment

Referring now to FIGS. 6 and 7 for a view of the camber-adjustment feature of this invention. As indicated above, most conventional wheelchairs have fixed zero degrees of camber. Wheelchair racers have long recognized that adding camber to the main wheels adds stability to the wheelchair and thus reduces the likelihood of overturning the wheelchair. Adding camber also allows the racer to utilize a more comfortable, slightly outward arm position for gripping the mobility booster lever arms 36 and 37 for greater speed and endurance.

The wheel support plate 38 is angularly adjustable from the vertical in its connection to the base section 15 and the U-shaped seat support 16 of the frame assembly 11. The camber adjustment employs a plurality of openings in the upper end 38V of the wheel support plate 38 and a retractable pin 50, which can fit into any of a series of adjustment holes 51, two of which appear in FIG. 6. The main attachment of the wheel support plate 38 to the frame assembly 11 is at the base section 15. There, a clamp assembly 52 encircles the tubular base section 15, and with its locking bolts 52B holds the camber angle selected.

In FIGS. 6 and 7, only two camber angles CA are shown, 0 degrees in FIG. 6 and in FIG. 7 an outward or positive camber is illustrated with the pin 50 located in the adjustment holes 51 and an approximate 7 degrees of camber. Said camber angles CA are limited in large part only by the number of adjustment holes 51 and their location for camber adjustment. Suffice it to say that camber adjustment of the wheel assemblies 12 and 13 by any adjustment means provides angular adjustment of the mobility booster lever arms 36 and 37 for the convenience and possibly improved endurance of the wheelchair user.

Third Wheel Steering Refinement

One form of the front wheel 14 and steering assembly is illustrated in FIG. 8 in which the wheel 14 is located directly below on the axis of rotation A of shaft 26 and coupled thereto by an interlocking pin 26P and slot 14ST combination. The wheel 14 is journaled on its L-shaped support bracket 14B, which in turn is mounted by bearing assembly 14BA and secured to the footrest tube 24 by clamp assembly 14CA. An alternate form of wheel caster, known as a trailing-type caster wheel 14WC also appears in FIG. 8. However, the preferred form of wheel 14 is as shown in place in FIG. 8 in which the axis of rotation A of the shaft 14S passes through the axis of rotation 14AR of the wheel 14 providing ease of operation as described above.

Frame Folding Features

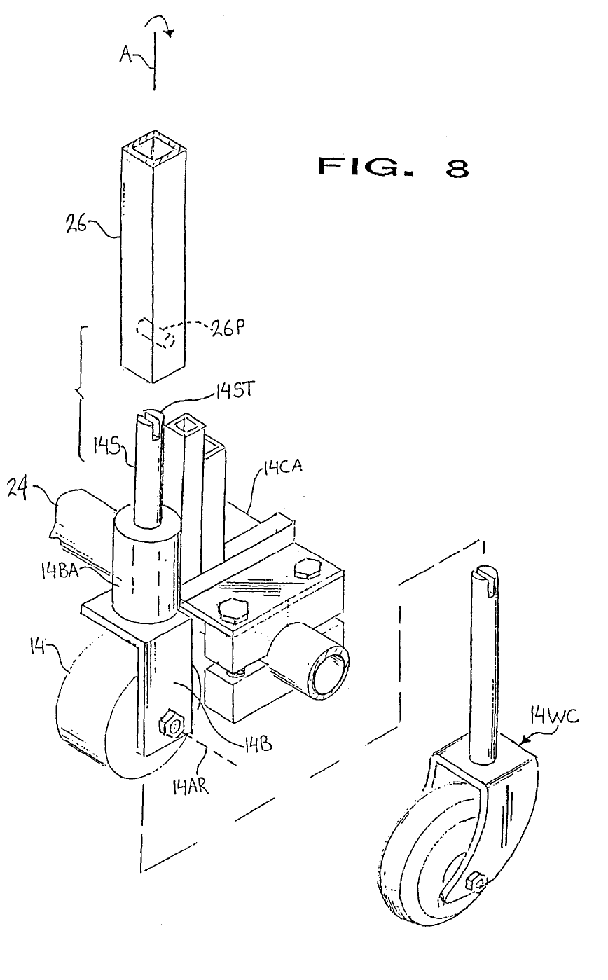

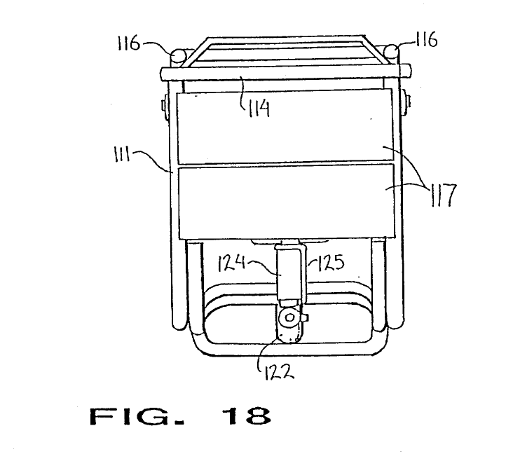

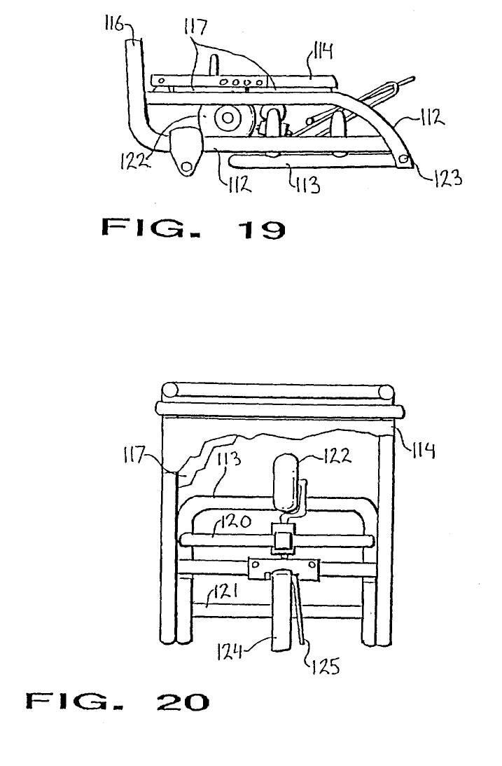

One additional feature of this invention is illustrated in FIGS. 9 and 10, as well as FIGS. 18-20. As is well recognized, the folding of a wheelchair for carriage in an automobile is a necessity for many wheelchair users. Typically, after the user exits the wheelchair, folding is accomplished by collapsing the sides together with the wheels attached. For many wheelchair users, that form of folding is acceptable and usually requires that the wheelchair be carried upright behind a front seat of an automobile or in the automobile trunk. For most wheelchair users, removal requires the assistance of another person who will open the back door or trunk, remove the wheelchair, and spread the wheelchair out into position. Although many wheelchairs are light in weight, many are too cumbersome for the user to remove and open while sitting in the front seat of an automobile without assistance.

My wheelchair is folded, stored and carried in an automobile in a different manner from the prior art. The frame is foldable after removal of both wheel assemblies 12 and 13 including mobility booster lever arms 36 and 37 as two separate units. In the embodiments of FIGS. 9 and 10, and FIGS. 18-20, the backrest 10B folds forward against the seat 10S and the U-shaped seat support 16. After release of the footrest stop bar 23, the footrest 24 and front wheel 14 may be folded upward parallel the U-shaped seat support 16 bringing the frame assembly 11 into a generally rectangular package, which may rest in the front seat foot well below the legs of the front right seat occupant who, in all probability, is the wheelchair user. The back of the backrest may act as a foot support for the front right seat occupant and provide comfort while riding in the automobile.

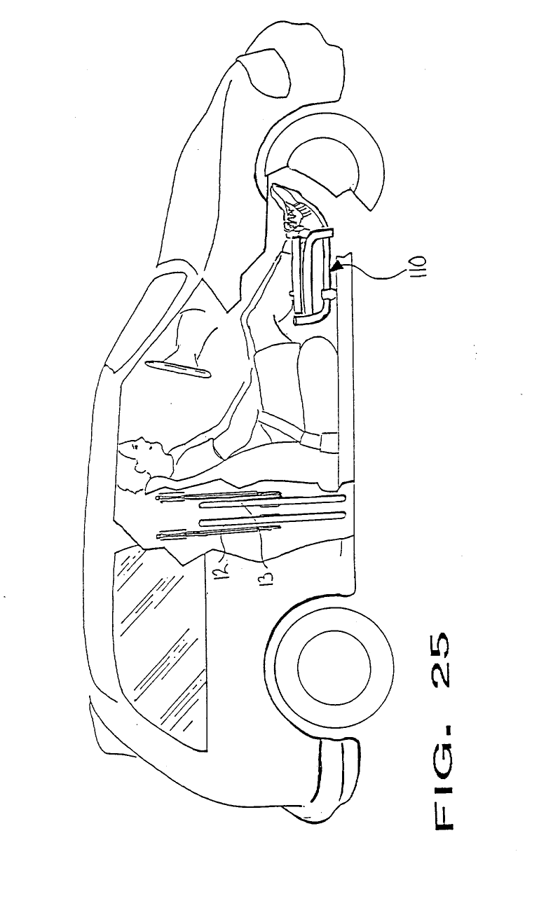

The wheel support plates 38 and 39 allow the folded frame to sit at a comfortable angle for the front right seat occupant. The wheels may each be placed behind the front seat by the user while sitting in the front right seat of the automobile simply by pulling the wheels into the automobile and placing them behind the seat. The stored position of the alternate frame embodiment is shown in FIG. 25. However, the same storage is found with the frame embodiment of FIGS. 1-3 and 8-10 as illustrated in FIG. 25 with a user shown as a passenger in an automobile.

By dividing the wheelchair into three manageable parts, the user is capable of handling the placement of the wheelchair in a vehicle by himself. If the wheelchair user is also the driver and does not have a helper, this feature is of significant benefit. It is recognized that the wheels must be removed and reassembled with the frame; however, quick-action fasteners, for removing and replacing bicycle wheels on their front forks, are well known and may be used in place of the conventional nuts illustrated in FIGS. 2, 4 and 5.

Normal Uses

The use of the wheelchair of this invention in traveling down an incline is illustrated in FIG. 11. The user grasps both mobility booster lever arms 36 and 37, only one of which appears in FIG. 11, while concurrently squeezing the brake handles (not shown) sufficiently to control the speed of descent. In order to stop on an incline or on level ground without having to continuously squeeze the brake handles, the wheelchair user has only to engage the brake locking rings 47 or 48, best seen in FIGS. 2A and 2B. Engagement of both brake locking rings 47 and 48 is recommended whenever the user desires no movement.

In those instances where the wheelchair user has limited strength or mobility in one arm but better capability in the other arm and still wants to be fully mobile, the wheelchair user may operate the removable steering arm 31 with one hand, which requires very little force to operate and propel the wheelchair 10 using only one wheel assembly 12 or 13.

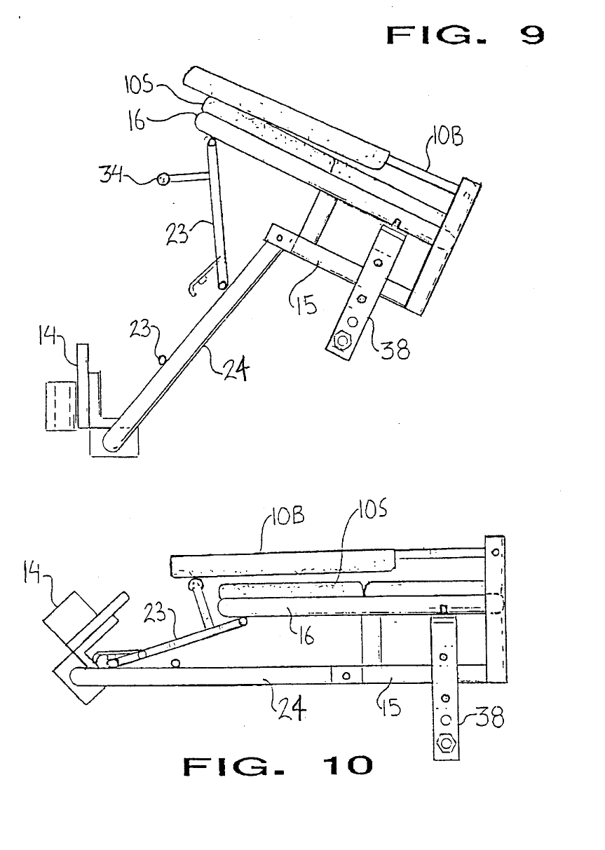

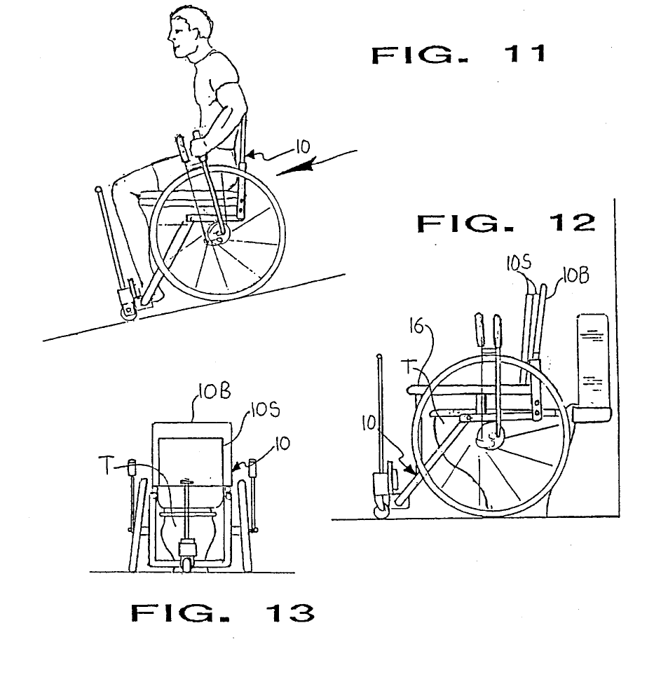

The frame assembly 11, illustrated in FIGS. 2, 3, 9, and 10, provides another feature which is illustrated in FIGS. 12 and 13. The frame assembly 11 has no cross bar at the rear, and the seat 10S is foldable against the backrest 10B. This leaves the seat area open. The U-shaped seat support member 16 is located at a height of at least 16 inches from the floor, which means that the wheelchair of this invention may be backed over most residential and commercial toilets such that the user may sit on the regular toilet seat after having raised the wheelchair seat 10S out of the way. After using the toilet, the wheelchair user slips the wheelchair seat back in place and propels himself forward using the mobility booster lever arms 36 and 37, as described above and away from the toilet without assistance. This feature is intended to provide the user with additional degrees of freedom.

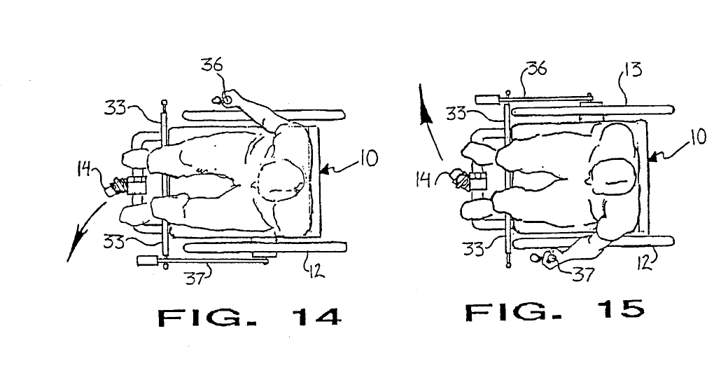

The freedom to self propel this wheelchair and make abrupt changes of direction is illustrated in FIGS. 14 and 15. By engaging one brake in one wheel and concurrently operating the other wheel via the mobility booster arm, the wheelchair will pivot about the locked wheel, as for example to the left in FIG. 15. By holding the brake of wheel 13W locked and concurrently operating the other wheel, the wheelchair will pivot about the locked wheel and turn to the right as shown in FIG. 14. It is also possible to operate both main wheels 12W and 13W in opposite directions by opposite driving of the mobility booster lever arms and turn the wheelchair without any movement either forward or backward, e.g., “turning on a dime”. This adds a significant degree of mobility heretofore not available to most wheelchair users.

Alternate Frame Design

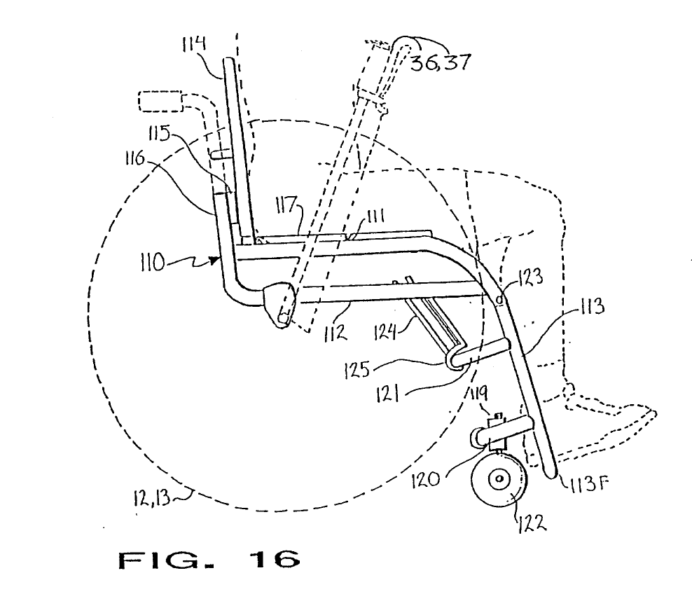

FIGS. 16-20 illustrate an alternate and preferred form of frame 110 having an upper seat frame 111 and a lower seat frame 112, and a U-shaped leg rest frame 113. The upper frame member 111 pivotally supports the backrest 114 from its upper position resting against pads 115 on the upturned end 116 of the lower seat frame 112. The upturned end 116 may receive optional handles shown in dashed lines for use by assistants, if desired.

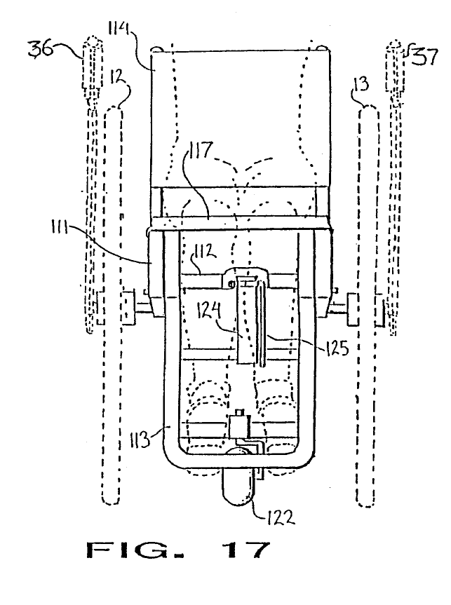

The leg rest frame 113 includes a bottom U-shaped footrest 113F and a pair of cross braces 120 and 121. Brace 120 supports the single front wheel 122 journaled in bearing assembly 119. The leg rest frame 113 is pivoted about joint 123 when not in use for rearward folding and storage. The seat 117 is shown in its occupant-supporting position in FIGS. 16 and 17. For perspective, the user and the main wheels 12W and 13W are shown in dashed lines, as are the mobility booster lever arms 36 and 37.

Storage in a Passenger Vehicle

FIGS. 18-20 show the frame 110 of FIGS. 16 and 17 in folded condition and ready for storage. Note that when folded, the frame, with its seat 117, backrest 114, leg rest 113, and front wheel 122 form a generally rectangular package in the order of 19 inches wide by 20 inches long by 10 inches high, a size which conveniently rests in the foot well of a passenger vehicle. Such placement is illustrated in FIG. 25.

In FIG. 25, a typical small sedan is shown, partly in section, with a passenger seated in the front right hand seat. His legs on the folded frame 110 and the two main wheel assemblies 12 and 13 are within easy reach of the passenger for placement and removal. Upon entering the vehicle with the side door open, the wheelchair user slips into the vehicle seat, removes the near main wheel assembly 12 and stores it behind the front seat. He next folds the frame 110 to its packed form and removes the main wheel assembly 13 and also stores it behind the front seat. The frame may be lifted into the vehicle and placed under the passenger's leg acting as a leg rest during the vehicle travel. It is believed that this can all be performed by most wheelchair users without the need for assistance. Additionally, the mobility booster lever arms 36 and 37 act as handles for wheel assemblies 12 and 13 as does the upturned end 116 of the frame, all of which makes vehicle storage easier to complete.

Reassembly of the wheelchair is basically a reversal of these steps.

The Mobility Booster Lever Arms Applied to Existing Wheelchairs

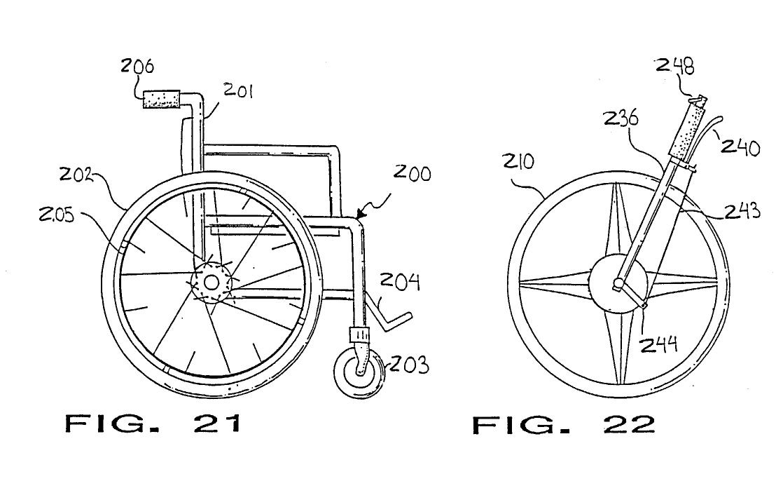

While experimenting with this invention, it appeared to me that certain of the features of this invention can be easily adapted to conventional wheelchairs to add to their capability. In particular, the main wheel assemblies, including the mobility booster lever arms and brake system, may be substituted for a conventional pair of wheels and all of the features of the mobility boosters described above become available to the user of an otherwise conventional wheelchair. This is illustrated in FIGS. 21-24.

FIG. 21 shows a conventional folding wheelchair 200 with its frame 201, main wheels 202, small front wheels 203, and footrest 204. The main wheels include hand rims 205, which are used by the wheelchair user to self propel the wheelchair 200. An assistant uses handles 206 to push the wheelchair 200 and its occupant conventionally.

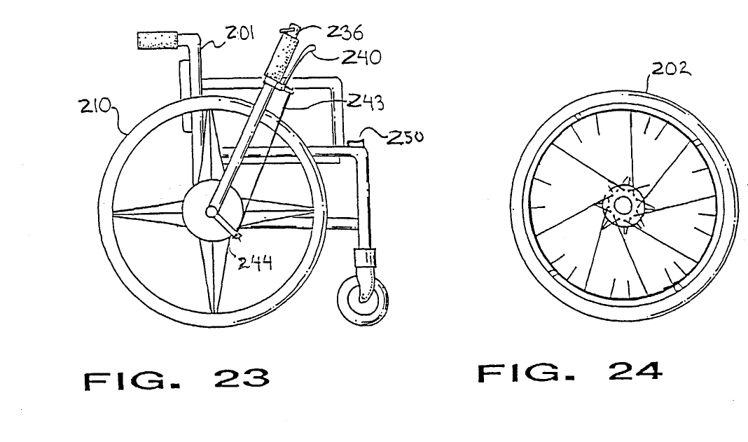

The conventional main wheels 202, FIG. 24, are removable and a pair of mobility booster wheel assemblies 210 of FIG. 22 may be substituted for the conventional main wheels 202 to achieve all of the advantages of these mobility boosters described above, FIG. 23. Thus, there is no need to replace the present wheelchair. The mobility booster wheel assemblies 210 includes a spoke wheel, as illustrated in FIG. 22, but alternatively may include a rigid spoke configuration or any other similar type configuration. The replacement mobility wheel assembly 210 includes the lever arm 236 with its brake handle 240, rod or cable 243, and brake arm 244 connected to the internal brake hub and brake lock 248.

After conversion, the wheelchair 200 has the appearance as shown in FIG. 23. In addition to the mobility booster wheel assembly 210 of FIG. 22, the only other addition required for the wheelchair 200 is a stop 250, which is merely an add-on plate or rod extending outward on each side of the wheelchair frame 201 to limit the forward rotation of the levers 236 on each side of the wheelchair 200.

The above-described embodiments of the present invention are merely descriptive of its principles and are not to be considered limiting. The scope of the present invention instead shall be determined from the scope of the following claims, including their equivalents.

I claim:

1. A wheelchair comprising:
a frame having a front, a rear, and a pair of sides;
a seat and a backrest on said frame providing a chair seat for a wheelchair user;
a footrest secured to the front of said frame;
a pair of main wheels, each of said main wheels including a hub rotatably secured to each side of said frame;
a pair of manual lever arms, one for each main wheel to drive the main wheels independent of each other;
said manual lever arms are directly coupled to said main wheels;
said manual lever arms have a greater length than the radius of said main wheels whereby the manual lever arms provide a greater moment arm for driving or stopping the main wheels;
said frame includes a stop means engagable with said manual lever arms thereby limiting the angle of movement of said manual lever arms in at least one direction;
a pair of brakes, one in the hub of each of said wheels;
a pair of manual controls for said brakes, one for each brake;
said manual controls for said brakes being operative to engage said lever arm with said respective wheel through said brake for both driving and braking its respective wheel; and
at least one additional wheel rotatably coupled to said frame for supporting the wheelchair with said main wheels.

2. A wheelchair in accordance with claim 1 wherein said manual controls for said brakes are located on respective manual lever arms for operation thereof.

3. A wheelchair in accordance with claim 1 wherein said manual lever arms each include a hand grip portion and said manual controls for said brakes are located within reach of said hand grip portions;
each of said brakes interconnecting a respective manual lever arm to its respective wheel;
whereby the wheelchair user may drive the wheelchair by independent or simultaneous operation of said manual lever arms whenever the manual control for said brakes is operated.

4. A wheelchair in accordance with claim 3 wherein said handgrip portions of said manual lever are located outside of said frame when in a manual-operating positions.

5. A wheelchair in accordance with claim 1 including a pair of main wheel camber-adjusting means attaching respective wheels to said frame, whereby said wheels, brake assemblies, and said lever arms may be adjusted in camber.

6. A wheelchair in accordance with claim 1 wherein said brake assembly comprises drum and brake shoes forming a part of the hub of said main wheels.

7. A wheelchair in accordance with claim 1 wherein said brakes are drum and shoe brakes integrated into each of said main wheels with said drum secured to said wheel and said shoe operatively connected to said manual brake control.

8. A wheelchair in accordance with claim 1 wherein said at least one additional wheel having a manual steering means is pivotally secured to said footrest

9. A wheelchair in accordance with claim 1 including manually operable brake lock means.

10. A Wheelchair in accordance with claim 9 wherein said manually operable brake lock means is secured to at least one of said manual lever arms.

11. A wheelchair in accordance with claim 9 including individual brake lock means for each wheel.

12. A wheelchair comprising:
a frame having a front, a rear, and a pair of sides;
a seat and a backrest on said frame providing a chair seat for a wheelchair user;
a footrest secured to the front of said frame;
a pair of main wheels, one of said pair of main wheels rotatably secured to each side of said frame;
said wheels elevating said seat to a level corresponding to the level of a toilet seat in the order of 16 inches from the floor or more;
said wheelchair being unobstructed to the rear between said main wheels at or below the level of a toilet seat;
said seat being movable from a normal occupant-supporting position to a position wherein said frame is approximately level with the top of a toilet seat and the seat of the toilet is approximately at the level of the wheelchair seat when the wheelchair seat is in its normal occupant-supporting position;
whereby the occupant may back the wheelchair over a toilet, move the wheelchair seat to a non-position to allow the occupant to be supported by the seat of the toilet and utilize the toilet in a conventional manner, return the seat of the wheelchair to its occupant-supporting position and leave the toilet.

13. A wheelchair in accordance with claim 12 wherein said frame is U-shaped with the opening of the U toward the rear of the frame to facilitate the backing of the wheelchair over a toilet.

14. A wheelchair in accordance with claim 12 wherein said wheelchair seat is foldable from a normal occupant-supporting position to an elevated position to allow the occupant to utilize a toilet while remaining in the wheelchair.

15. A wheelchair in accordance with claim 14 wherein said seat s foldable against the wheelchair backrest.

16. A wheelchair in accordance with claim 12 wherein said main wheels are spaced at least 15 inches apart at or below 16 inches from the bottom of said wheels to allow the wheelchair to back over a toilet.

17. A wheelchair in accordance with claim 12 wherein said frame is unobstructed from the rear at or below 16 inches from the level of the bottom of said wheel.

18. A wheelchair in accordance with claim 12 wherein said wheelchair includes at least one additional wheel secured to said frame at the front thereof in non-interfering position when the wheelchair is backed over a toilet.

19. A wheelchair in accordance with claim 18 wherein said at least one additional wheel is secured to said footrest.

20. A wheelchair comprising;
generally rectangular frame;
pair of main wheels rotatably connected to said frame, one on either side thereof;
a seat secured to said frame for supporting an occupant of the wheelchair;
a backrest secured to said frame for providing back support for the occupant of the wheelchair;
said backrest being foldable against said seat;
a footrest for said wheelchair pivotally secured to said frame;
said footrest foldable against said frame;
said main wheels are removable from said frame for transport;
whereby said frame, backrest and footrest when folded define a generally rectangular shape.

21. A wheelchair in accordance with claim 20 wherein said backrest is pivotally secured to said frame to fold over said seat.

22. A wheelchair in accordance with claim 20 wherein said footrest is generally U-shaped with the arms of the U pivotally secured to the front of said frame and the base of the U providing two footrest areas.

23. A wheelchair in accordance with claim 20 wherein said footrest include locking means to secure said footrest in an occupant foot-supporting position below and in front of said frame and said locking means is releasable to allow said footrest to fold under said frame for transport.

24. A wheelchair in accordance with claim 23 wherein said footrest mounts said at least one additional wheel.

25. A wheel chair in accordance with claim 20 wherein said footrest is generally U-shaped with the arms of the U secured to said frame and two occupant foot-supporting portions at the base of said U and said at least one additional wheel is swivel mounted to said footrest at a position between said two occupant foot supporting positions.

26. A wheelchair in accordance with claim 24 including a manually controllably shaft coupled to said one additional wheel to allow manual steering of said one additional wheel.

27. A wheelchair in accordance with claim 26 wherein said footrest is pivotally secured to said frame at the front thereof to selectively be folded against the underside of the frame.

28. A compact folding three-wheeled wheelchair comprising:
a frame having a seat, a backrest and a folding leg support;
a pair of main wheels attachable to the sides of said frame;
a third wheel generally centrally located and pivotally secured to said folding leg support;
said main wheels being removable from said frame for storage separate from said frame;
said backrest being foldable to a position generally parallel to said seat;
said leg support and third wheel being foldable from the front of said frame rearward with said third wheel stored substantially within the folded frame;
said folded frame dimensioned to form a generally rectangular package for storage and transport;
wherein each of said main wheels includes a hub, an internal brake incorporated into said hub, and a booster lever arm directly and rotatably secured to its respective wheel through said brake;
said booster lever arm having a greater length than the radius of said main wheel and extending beyond the tire and rim of its respective wheel including hand grips for operating the booster lever arm and including brake operating means for engaging the brake.

29. A compact folding wheelchair in accordance with claim 28;
wherein said frame includes a U-shaped frame seat support member with the opening of the U being to the rear of the wheelchair and;
said seat is movable from a first user supporting position to a second non user supporting position whereby;
said wheelchair may be backed over a toilet for unassisted use by the wheelchair user without leaving the wheelchair.

30. A compact folding wheelchair in accordance with claim 28 wherein said seat is foldable from the user supporting first position to a folded second position outside of the user support position whereby the user may sit on the seat of a toilet and lean against said backrest.

31. A compact folding wheelchair in accordance with claim 29 wherein said seat is foldable against said backrest.

32. A compact folding wheelchair in accordance with claim 28 including a manually controlled steering means for said third wheel.

33. A compact folding wheelchair in accordance with claim 32 wherein said manual controlled steering means is pivotally secured to said third wheel and said footrest.

34. A compact folding wheelchair in accordance with claim 32 wherein said manually controllable steering means is removably coupled to said third wheel to allow for the users entry into the wheelchair.

35. A compact folding wheelchair in accordance with claim 32 wherein said manually controlled steering means is pivoted about said footrest on the axis of rotation of said third wheel.

36. In a wheelchair including a frame, a seat and backrest for the user of the wheelchair, in which the frame supports the seat and backrest, a pair of main wheels secured at each side of the frame in the seat region thereof, at least one auxiliary wheel and footrests for the feet of a user of the wheelchair:
the improvement therein in which said frame which is open at the rear, the seat is movable to a user non-supporting position whereby the wheelchair may be backed over a toilet seat for use by the user of the wheelchair without exiting the wheelchair.

37. A wheelchair in accordance with claim 36 wherein said seat is positioned by said frame in the order of 16 inches to 20 inches above the bottom of the main wheels on the supporting surface for the wheelchair, whereby on moving the wheelchair seat to a user non-supporting position, the wheelchair user may rest on the toilet seat at substantially the same height as when seated in the wheelchair.

38. A wheelchair in accordance with claim 36 wherein said seat is foldable against the backrest as the user non-supporting position.

39. A wheelchair in accordance with claim 36 wherein said frame includes a generally U-shaped frame member with a pair of arms at each side of the frame and the opening of the U is located at the rear of the wheelchair whereby the frame does not interfere with backing the wheelchair over a toilet.

40. A wheelchair in accordance with claim 36 wherein the arms of the generally U-shaped frame member are spaced at least 15 inches apart whereby said arms are located at each side of a toilet seat when the wheelchair is backed over a toilet.

41. In a wheelchair including a frame, a seat and backrest for a user of the wheelchair, in which the frame supports the seat and backrest, a pair of main wheels each including a rim, a tire, and a hub with said main wheels secured at each side of the frame, at least one auxiliary wheel and a footrest for the feet of said user of the wheelchair;
the improvement wherein said main wheels each have a brake in the hub thereof;
an arm pivotally coupled to each said brake extending beyond said rim and tire of each main wheel; and
means on each said arm for operating its respective brake whereby said arms and brake-operating means cooperate with their respective wheel to which said arm and brake operating means is attached and for driving said wheel.

42. A wheelchair in accordance with claim 41 wherein said arms extend outside of said frame for reciprocal operation to drive each said arm's associated main wheel and for braking each said arm's associated main wheel by operation of said brake operating means.

43. A wheelchair in accordance with claim 41 wherein said brake operating means comprises a handle secured to said arm in the region of said arm which extends beyond said rim and tire of the associated main wheel.

44. A power booster assembly for substitution for the main wheels on a wheelchair comprising:
a pair of replacement main wheels, each of said replacement main wheels having a hub and ground engaging rolling surface with a diameter comparable to the diameter of the main wheel of the wheelchair wheel to be replaced and further including a brake assembly forming a part of the hub;
a pair of arms each directly and rotatably secured to a respective replacement main wheel through its brake assembly;
brake actuating means secured to each arm and coupled to a brake assembly and to engage the arm to the replacement main wheel to drive and release selectively the replacement main wheel for free wheeling;
said pair of arms having lengths greater than the radius of said wheels whereby said arms provide a greater moment arm than when said wheel is manually operated to drive said wheelchair.

45. A power booster in accordance with claim 44 including manually controllable brake lock means for selectively engaging the brake assembly for preventing the rotation of a replacement main wheel independent of said arm.

46. A power booster in accordance with claim 44 including stop means securable to the wheelchair to engage one of said pair of arms to limit its rotation in at least one direction.

47. A power booster in accordance with claim 46 including a second stop means for engaging the second of said pair of arms for limiting the rotation of said second of said pair of arms in at least one direction.

48. A power booster in accordance with claim 44 wherein said pair of arms each have a hand grip at the end region thereof opposite from the end attachment to said brake assembly, and said brake actuating means includes a hand operated lever adjacent to said hand grips for selective actuation of the brake assembly associated with its respective arm and replacement wheel.

49. A power booster in accordance with claim 44 wherein each of said brake assemblies includes a drum and brake shoe with said brake shoe being coupled to said brake actuating means and actuated into contact with said brake drum by manual operation of said brake actuating means.

50. A wheelchair as claimed in claim 1 wherein said wheelchair only has three wheels including said pair of main wheels and a third wheel rotatably coupled to and generally centrally located on said frame cooperating with said main wheels for supporting said wheelchair.

51. A wheelchair in accordance with claim 50 wherein said brake assembly comprises drum and brake shoes forming a part of the hub of said main wheels.

52. A wheelchair in accordance with claim 50 wherein said manual controls for said brakes are located on respective manual lever arms for operation thereof.

53. A wheelchair in accordance with claim 50 wherein said manual lever arms have a greater length than the radius of said main wheels whereby the manual lever arms provide a greater moment arm for driving or stopping the main wheels and wherein said frame includes stop means engagable with said manual lever arms thereby limiting the angle of movement of said manual lever arms in at least one direction.

54. A wheelchair in accordance with claim 50 wherein said manual lever arms each include a hand grip portion and said manual controls for said brakes are located within reach of said hand grip portions;
each of said brakes interconnecting a respective manual lever arm to its respective wheel;
whereby the wheelchair user may drive the wheelchair by independent or simultaneous operation of said manual lever arms whenever the manual control for said brakes is operated.

55. A wheelchair in accordance with claim 50 wherein said third wheel is pivotally secured to said footrest, said third wheel having a manual steering means.

56. A compact folding wheelchair in accordance with claim 50
wherein said frame includes a U-shaped frame seat support member with the opening of the U being to the rear of the wheelchair; and
said seat is movable from a first user supporting position to a second non-user supporting position;
whereby said wheelchair may be backed over a toilet for unassisted use by the wheelchair user without leaving the wheelchair.

57. A compact folding wheelchair in accordance with claim 55
wherein said seat is foldable from the user supporting first position to a folded second position outside of the user support position;
whereby the user may sit on the seat of a toilet and lean against said backrest.

58. A compact folding wheelchair in accordance with claim 56 wherein said seat is foldable against said backrest.

59. A compact folding wheelchair in accordance with claim 50 including manually controlled steering means pivotally secured to said third wheel and said footrest.

60. A compact folding three-wheeled wheelchair comprising:
a frame having a seat, a backrest and a folding leg support;
a pair of main wheels attachable to the sides of said frame;
a third wheel pivotally secured to said folding leg support;
said main wheels being removable from said frame for storage separate from said frame;
said backrest being foldable to a position generally parallel to said seat;
said leg support and third wheel being foldable from the front of said frame rearward with said third wheel stored substantially within the folded frame;
said folded frame dimensioned to form a generally rectangular package for storage and transport;
wherein each of said main wheels includes a hub, an internal brake incorporated into said hub, and a booster lever arm rotatably secured to its respective wheel through said brake;
said booster lever arm extending beyond the tire and rim of its respective wheel including hand grips for operating the booster lever arm and including brake operating means for engaging the brake;
said manual lever arms have a greater length than the radius of said main wheels whereby the manual lever arms provide a greater moment arm for driving or stopping the main wheels than by the user grasping the wheels directly;
said frame includes a stop means engagable with said manual lever arms thereby limiting the angle of movement of said manual lever arms in at least one direction.

61. A compact folding wheelchair in accordance with claim 60;
wherein said frame includes a U-shaped frame seat support member with the opening of the U being to the rear of the wheelchair and;
said seat is movable from a first user supporting position to a second non-user supporting position whereby;
said wheelchair may be backed over a toilet for unassisted use by the wheelchair user without leaving the wheelchair.

62. A compact folding wheelchair in accordance with claim 60 wherein said seat is foldable from the user supporting first position to a folded second position outside of the user support position whereby the user may sit on the seat of a toilet and lean against said backrest.

63. A compact folding wheelchair in accordance with claim 60 herein said seat is foldable against said backrest.

64. A compact folding wheelchair in accordance with claim 60 including a manually controlled steering means for said third wheel.

65. A compact folding wheelchair in accordance with claim 64 wherein said manual controlled steering means is pivotally secured to said third wheel and said footrest.

66. A compact folding wheelchair in accordance with claim 64 wherein said manually controllable steering means is removably coupled to said third wheel to allow for a wheelchair user's entry into the wheelchair.

67. A compact folding wheelchair in accordance with claim 64 wherein said manually controlled steering means is pivoted about said footrest on the axis of rotation of said third wheel.
